(19) United States
(12) Patent Application Publication
(10) Pub. No.: US 2026/0208706 A1
(43) Pub. Date: Jul. 23, 2026

(54) MOTOR VELOCITY CONTROL SELECTION METHOD FOR ELECTRIC BRAKE ACTUATOR CONTROLLER (EBAC)

(71) Applicant: Goodrich Corporation, Charlotte, NC (US)

(72) Inventors: Kaman Thapa Magar, Beavercreek, OH (US); Resham Bains, Tipp City, OH (US); Marc J. Georgin, Oakwood, OH (US)

(73) Assignee: Goodrich Corporation, Charlotte, NC (US)

(21) Appl. No.: 19/447,851

(22) Filed: Jan. 13, 2026

Related U.S. Application Data
(60) Provisional application No. 63/747,501, filed on Jan. 21, 2025.

(51) Int. Cl. B60T 8/17; B60T 13/74

(52) U.S. Cl. CPC B60T 8/1703; B60T 13/746

(57) ABSTRACT

An improved motor velocity control selection mechanism. An electromechanical brake (E-brake) system includes a brake control unit, an electromechanical brake actuator controller coupled to the brake control unit, and at least one brake coupled to the electromechanical brake actuator controller. The electromechanical brake actuator controller includes a velocity controller. The velocity controller is configured to command a braking force via an electromechanical brake actuator to the at least one brake based upon whether a command to go to at least one of zero torque point (ZTP) or running clearance point (RCP) has been received and at least one of a force error, a ZTP flag, and a measured electric brake actuator position.

### CROSS-REFERENCE TO RELATED APPLICATIONS

This application claims priority to and the benefit of, U.S. Provisional Application No. 63/747,501, filed Jan. 21, 2025, and entitled “MOTOR VELOCITY CONTROL SELECTION METHOD FOR ELECTRIC BRAKE ACTUATOR CONTROLLER (EBAC),” which is incorporated by reference herein in its entirety for all purposes.

### FIELD

The present disclosure generally relates to aircraft brake systems, and more specifically, to an improved motor velocity control selection method for electric brake actuator controller (EBAC).

### BACKGROUND

Typically, an aircraft may comprise an electromechanical brake (E-brake) system that utilizes a plurality of electromechanical brake actuators (EBAs) configured to apply force to a brake stack on an aircraft wheel. As aircrafts are converted to utilize more electricity and thus utilize such E-brake systems, there is a need for E-brake architectures that address two-wheel aircrafts, such as business jets, as well as four-wheel aircraft for Next Generation Single-Aisle (NGSA) and regional jets.

### SUMMARY

An electromechanical brake (E-brake) system is disclosed herein. The E-brake) system includes a brake control unit, an electromechanical brake actuator controller coupled to the brake control unit, and at least one brake coupled to the electromechanical brake actuator controller. The electromechanical brake actuator controller includes a velocity controller. The velocity controller is configured to command a braking force via an electromechanical brake actuator to the at least one brake based upon whether a command to go to at least one of zero torque point (ZTP) or running clearance point (RCP) has been received and at least one of a force error, a ZTP flag, and a measured electric brake actuator position.

In various embodiments, the electromechanical brake actuator controller further includes a position controller. In various embodiments, the position controller is configured to provide a corrective position command to the velocity controller based on a received position command from the brake control unit and a position indication of the at least one brake. In various embodiments, the velocity controller is configured to command the braking force to the at least one brake via the electromechanical brake actuator utilizing a velocity command from the brake control unit and the corrective position command responsive to receiving the command to go to the at least one of zero torque point (ZTP) or running clearance point (RCP) and responsive to the ZTP flag being valid.

In various embodiments, the position indication is received from a resolver associated with the electromechanical brake actuator of the at least one brake.

In various embodiments, the electromechanical brake actuator controller further includes a force controller. In various embodiments, the force controller is configured to provide a corrective force command to the velocity controller based on a received force command from the brake control unit and a force indication associated with the electromechanical brake actuator of the at least one brake. In various embodiments, responsive to receiving the command to go to the at least one of zero torque point (ZTP) or running clearance point (RCP) and responsive to the ZTP flag being in valid, the velocity controller is configured to command the braking force to the at least one brake via the electromechanical brake actuator utilizing the velocity command from the brake control unit and the corrective force command responsive to determining that the position indication is greater than −125 mils.

In various embodiments, responsive to receiving the command to go to the at least one of zero torque point (ZTP) or running clearance point (RCP), responsive to the ZTP flag being in valid, and responsive to determining that the position indication is at or less than the −125 mils, the velocity controller is configured to command the braking force to the at least one brake via the electromechanical brake actuator utilizing only the velocity command from the brake control unit.

In various embodiments, the electromechanical brake actuator controller further includes a force controller. In various embodiments, the force controller is configured to provide a corrective force command to the velocity controller based on a received force command from the brake control unit and a force indication associated with the electromechanical brake actuator of the at least one brake. In various embodiments, the velocity controller is configured to command the braking force to the at least one brake via the electromechanical brake actuator utilizing a velocity command from the brake control unit and the corrective force command responsive to failing to receive the command to go to the at least one of zero torque point (ZTP) or running clearance point (RCP) and responsive to the force error being greater than zero (0). In various embodiments, the force error is determined by comparing a commanded force to a current measured force.

In various embodiments, the force indication is received from a load cell associated with the electromechanical brake actuator of the at least one brake.

In various embodiments, responsive to the force error being equal to or less than zero (0) and responsive to the ZTP flag being in valid, the velocity controller is configured to command the braking force to the at least one brake via the electromechanical brake actuator utilizing the velocity command from the brake control unit and the corrective force command responsive to determining that a position indication of the at least one brake is greater than −125 mils.

In various embodiments, responsive to the force error being equal to or less than zero (0), responsive to the ZTP flag being in valid, and responsive to determining that a position indication of the at least one brake is at or less than the −125 mils, the velocity controller is configured to command the braking force to the at least one brake via the electromechanical brake actuator utilizing only the velocity command from the brake control unit.

In various embodiments, responsive to the force error being equal to or less than zero (0) and responsive to the ZTP flag being in valid, the velocity controller is configured to command the braking force to the at least one brake via the electromechanical brake actuator utilizing the velocity command from the brake control unit and the corrective force command responsive to determining an EBA position indication is equal to or less than a ZTP value.

In various embodiments, responsive to the force error being equal to or less than zero (0), responsive to the ZTP flag being in valid, and responsive to determining an EBA position indication is greater than a ZTP value, the velocity controller is configured to command the braking force to the at least one brake via the electromechanical brake actuator utilizing only the velocity command from the brake control unit.

Also disclosed herein is a method for controlling a force applied to at least one brake of an electromechanical brake (E-brake) system. The method includes commanding, by a velocity controller, a braking force via an electromechanical brake actuator to the at least one brake based upon whether a command to go to at least one of zero torque point (ZTP) or running clearance point (RCP) has been received and at least one of force error, a ZTP flag, and a measured electric brake actuator position.

In various embodiments, the method further includes commanding, by the velocity controller, the braking force to the at least one brake via the electromechanical brake actuator utilizing a velocity command from a brake control unit and a corrective position command from a position controller, responsive to receiving a command to go to the at least one of zero torque point (ZTP) or running clearance point (RCP) and responsive to the ZTP flag being valid.

In various embodiments, the method further includes, responsive to receiving the command to go to the at least one of zero torque point (ZTP) or running clearance point (RCP) and responsive to the ZTP flag being in valid, commanding, by the velocity controller, the braking force to the at least one brake via the electromechanical brake actuator utilizing the velocity command from the brake control unit and a corrective force command from a force controller responsive to determining that a position indication is greater than −125 mils.

In various embodiments, the method further includes, responsive to receiving the command to go to the at least one of zero torque point (ZTP) or running clearance point (RCP), responsive to the ZTP flag being in valid, and responsive to determining that a position indication is at or less than the −125 mils, commanding, by the velocity controller, the braking force to the at least one brake via the electromechanical brake actuator utilizing only the velocity command from the brake control unit.

In various embodiments, the method further includes commanding, by the velocity controller, the braking force to the at least one brake via the electromechanical brake actuator utilizing a velocity command from a brake control unit and a corrective force command from a force controller, responsive to failing to receive the command to go to the at least one of zero torque point (ZTP) or running clearance point (RCP) and responsive to a force error being greater than zero (0). In various embodiments, the force error is determined by comparing a commanded force to a current measured force.

In various embodiments, the method further includes, responsive to the force error being equal to or less than zero (0) and responsive to the ZTP flag being in valid, commanding, by the velocity controller, the braking force to the at least one brake via the electromechanical brake actuator utilizing the velocity command from the brake control unit and the corrective force command responsive to determining that a position indication of the at least one brake is greater than −125 mils.

In various embodiments, the method further includes, responsive to the force error being equal to or less than zero (0), responsive to the ZTP flag being in valid, and responsive to determining that a position indication of the at least one brake is at or less than the −125 mils, commanding, by the velocity controller, the braking force to the at least one brake via the electromechanical brake actuator utilizing only the velocity command from the brake control unit.

In various embodiments, the method further includes, responsive to the force error being equal to or less than zero (0) and responsive to the ZTP flag being in valid, commanding, by the velocity controller, the braking force to the at least one brake via the electromechanical brake actuator utilizing the velocity command from the brake control unit and the corrective force command responsive to determining an EBA position indication is equal to or less than a ZTP value.

In various embodiments, the method further includes, responsive to the force error being equal to or less than zero (0), responsive to the ZTP flag being in valid, and responsive to determining an EBA position indication is greater than a ZTP value, commanding, by the velocity controller, the braking force to the at least one brake via the electromechanical brake actuator utilizing only the velocity command from the brake control unit.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft having multiple landing gear and brakes, in accordance with various embodiments.

FIG. 2 illustrates an aircraft brake in accordance with various embodiments.

FIG. 3 illustrates a block diagram of an electromechanical brake actuator control system in accordance with various embodiments.

FIG. 4 illustrates an electric brake actuator control configuration, in accordance with various embodiments.

FIG. 5 illustrates a velocity command selection flowchart, in accordance with various embodiments.

FIG. 6 illustrates a table of velocity command selection criteria, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

Disclosed herein is a motor velocity control selection mechanism for an Electric Brake Actuator Controller (EBAC). Typical EBAC system includes a series of cascaded control loops with the innermost loop being the current control loop, followed by the velocity control loop, and the outer-most loops including the force control loop and the position control loop. In various embodiments, a velocity controller in the velocity control loop receives either a current position indication from a position controller in the position control loop or current force indication from a force controller in the force control loop as well as a velocity command obtained from the Brake Control Unit (BCU). In various embodiments, the motor velocity control selection mechanism for the EBAC is configured to address issues that may either prevent Electric Brake Actuators (EBAs) from following the velocity command from the BCU or cause unintended control operation. For example, in various embodiments, the motor velocity control selection mechanism is configured to address issues such as, responsive to the velocity command from the BCU is to go to zero torque point (ZTP) or go to running clearance point (RCP), the EBAC may not be able to perform the position if the ZTP has not yet been determined even though the BCU provides a velocity command to go to ZTP or to go to RCP. As another example, the motor velocity control selection mechanism is configured to address issues such as a load cell that is configured to measure the force feedback on an EBA reporting a force measurement that is either smaller (negative bias) or larger (positive bias) than the true force on the EBA. For example, the load cell might report either 400 pound-force (lbf) (positive load cell bias) or −400 lbf (negative load cell bias) when the EBA is off the brake stack and the true force on the EBA is 0 lbf. If a force command smaller than the bias value is commanded in presence of a positive load cell bias (for example a force command of 100 lbf is commanded when the load cell bias is 400 lbf), the force controller will not be able to track the commanded force because the load cell measurement will saturate at that bias value resulting in negative force error. Thus, in various embodiments, the motor velocity control selection mechanism is configured to address negative force errors that may result in negative motor velocity command from the force controller which may cause the motor to spin in reverse direction retracting the EBA until a physical backstop is encountered.

Existing aircraft control selection algorithms employ a mixed mode control along with force and position control methods, which uses the combination of position and force controller to control the force at lower values. This control needs a force threshold below which the mixed control mode is implemented and also an estimated brake stiffness value to convert the force command to corresponding position command to be used for the position controller. Accordingly, in various embodiments, the motor velocity control selection mechanism is configured to select a velocity command from the appropriate controller, i.e., the position controller or the force controller as well as disable a controller, if needed, to tackle one or more of the issues mentioned previously or other issues that may exist.

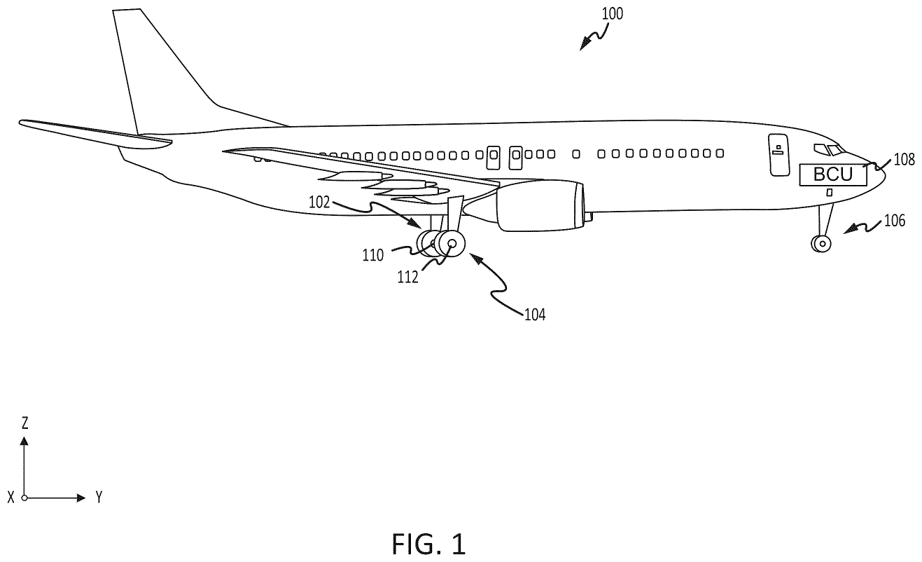

Referring to FIG. 1, in accordance with various embodiments, an aircraft 100 is illustrated. The aircraft 100 includes landing gear, which includes a left main landing gear 102, a right main landing gear 104, and a nose landing gear 106. The landing gear supports the aircraft 100 when it is not flying, allowing the aircraft 100 to taxi, take off, and land without damage. While the disclosure refers to the three landing gear configurations just referred, the disclosure nevertheless contemplates any number of landing gear configurations.

The aircraft 100 further includes one or more brake control units (BCU) 108 configured to control a left main brake mechanism 110 of the left main landing gear 102 and a right main brake mechanism 112 of the right main landing gear 104. The BCU 108 is configured to control the application of brake mechanisms 110 and 112 in response to input from aircraft 100 or an authorized user, i.e. the pilot. The BCU 108 is further configured to control a parking brake functionality of the brake mechanisms 110, 112 to secure the aircraft 100 in place. A plurality of wires that independently control the braking and parking brake functionalities run through the aircraft 100 from the BCU 108 to the left main brake mechanism 110 and the right main brake mechanism 112.

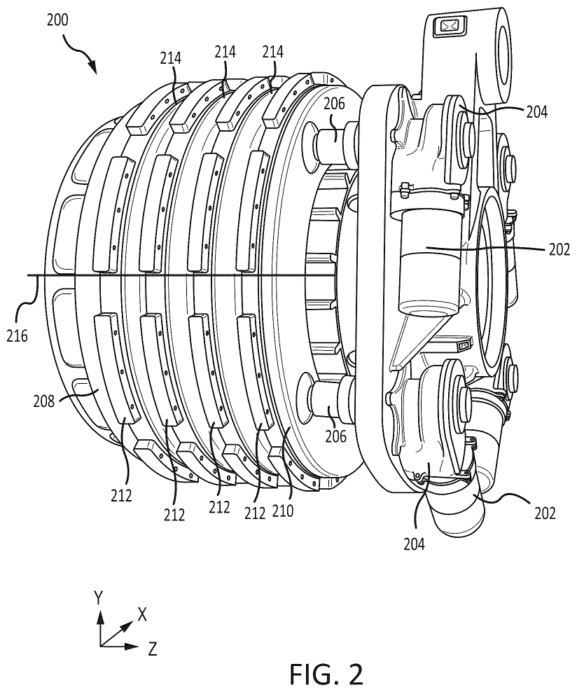

Referring to FIG. 2, an aircraft brake arrangement 200 in accordance with various embodiments is illustrated. The aircraft brake arrangement 200 may include a plurality of actuator motors 202, a plurality of electromechanical brake actuators (EBAs) 204, a plurality of ball screws 206, an end plate 208, and a pressure plate 210, and a plurality of rotating discs 212 and stators 214 positioned in an alternating fashion between the end plate 208 and the pressure plate 210. The rotating discs 212 may rotate about an axis 216 and the stators 214 may have no angular movement relative to the axis 216. Wheels may be coupled to the rotating discs 212 such that a linear speed of the aircraft is proportional to the angular speed of rotating discs 212. As force is applied to the pressure plate 210 towards the end plate 208 along the axis 216, the rotating discs 212 and the stators 214 are forced together in an axial direction. This causes the rotational speed of the rotating discs 212 to become reduced (i.e., causes braking effect) due to friction between the rotating discs 212, the stators 214, the end plate 208, and the pressure plate 210. In response to sufficient force being exerted on the rotating discs 212 via the pressure plate 210, the rotating discs 212 will stop rotating.

In order to exert this force onto the pressure plate 210, the actuator motor 202 may cause the EBA 204 to actuate. In various embodiments, the actuator motor 202 may be a brushless motor, such as a permanent magnet synchronous motor (PMSM), a permanent-magnet motor (PMM) or the like. In various embodiments, the EBA 204 may be coupled to or otherwise operate a motor shaft and a pressure generating device, such as, for example, a ball screw, a ram, and/or the like. In response to actuation or a brake command, the EBA 204 causes the actuator motor 202 to rotate. Rotation of the actuator motor 202 may cause rotation of the ball screw 206, and rotational motion of the ball screw 206 may be transformed into linear motion of ball screws 206. Linear translation of ball screws 206 towards pressure plate 210 applies force on pressure plate 210 towards end plate 208.

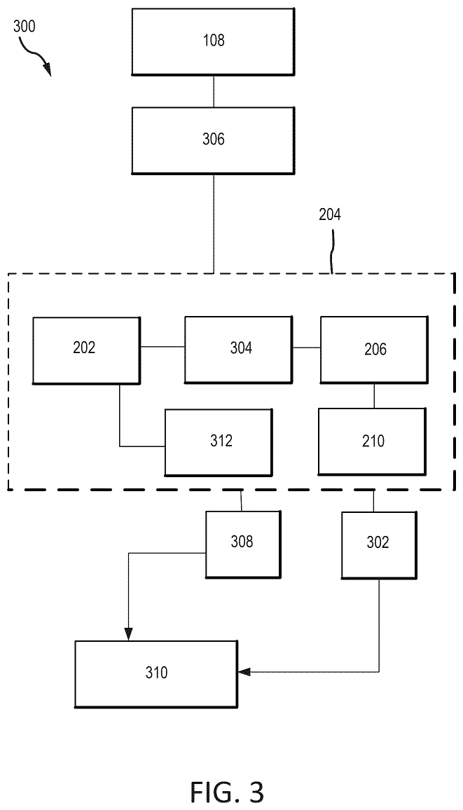

The EBA 204 is actuated in response to electrical current being applied to the actuator motor 202. The amount of force applied by the EBA 204 is related to the amount of electrical current applied to the actuator motor 202. With further reference to FIG. 3, in various embodiments, an electromechanical brake actuator control system 300, or brake system, may include an electromechanical brake actuator controller (EBAC) in communication with each EBA 204. In various embodiments, the electromechanical brake actuator control system 300 may include an electrical current sensor 312 to detect an amount of electrical current provided to actuator motor 202. The electrical current sensor 312 may be in communication with actuator motor 202 and/or with various other components of an EBA 204, an electromechanical brake actuator control system 300, and/or the aircraft 100 of FIG. 1. In various embodiments, the electrical current sensor 312 may be disposed on or adjacent to actuator motor 202. However, in various embodiments, the electrical current sensor 312 may be disposed in any location suitable for detection of electrical current supplied to the actuator motor 202, such as, for example, in the EBAC.

Application of electrical current to actuator motor 202 causes rotation of a motor shaft 304. In various embodiments, electromechanical brake actuator control system 300 may include a position sensor 308. The position sensor 308 may be configured so as to measure the rotational speed and position of the motor shaft 304. In various embodiments, the position sensor 308 may be disposed in or adjacent to EBA 204, or on or adjacent to actuator motor 202. However, the position sensor 308 may be disposed in any location suitable for detection of the rotational speed and position of motor shaft 304. In various embodiments, position sensor 308 may include a resolver, tachometer, or Hall sensor, among others.

In various embodiments, the electromechanical brake actuator control system 300 may include a load cell 302. The load cell 302 may be configured so as to measure the amount of force being applied between the ball screws 206 and the pressure plate 210. In various embodiments, the load cell 302 may be disposed in or adjacent to EBA 204, or on or adjacent to ball screws 206. However, load cell 302 may be disposed in any location suitable for detection of the force being applied between the ball screws 206 and the pressure plate 210. A controller may receive the detected force and rotational speed and calculate an adjusted force and an adjusted rotational speed based on those detected values. In various embodiments, the electromechanical brake actuator control system 300 may include a fault tolerant module 310.

In various embodiments, a system for brake actuator operation with load cell fault tolerant technology includes four load cells 302, four electrical current sensors 312, four position sensors 308, and at least one controller. The system for multiple brake actuator operation via one load cell may include a fault tolerant module 310. In various embodiments, the fault tolerant module 310 may be a controller and/or processor. In various embodiments, the fault tolerant module 310 may be implemented in a single controller and/or processor. In various embodiments, the fault tolerant module 310 may be implemented in multiple controllers and/or processors. In various embodiments, the fault tolerant module 310 may be implemented in an electromechanical actuator controller and/or a brake control unit. With reference to FIGS. 1, 2, and 3, in various embodiments, the BCU 108 and thus, the EBAC 306, are configured to control the EBAs 204.

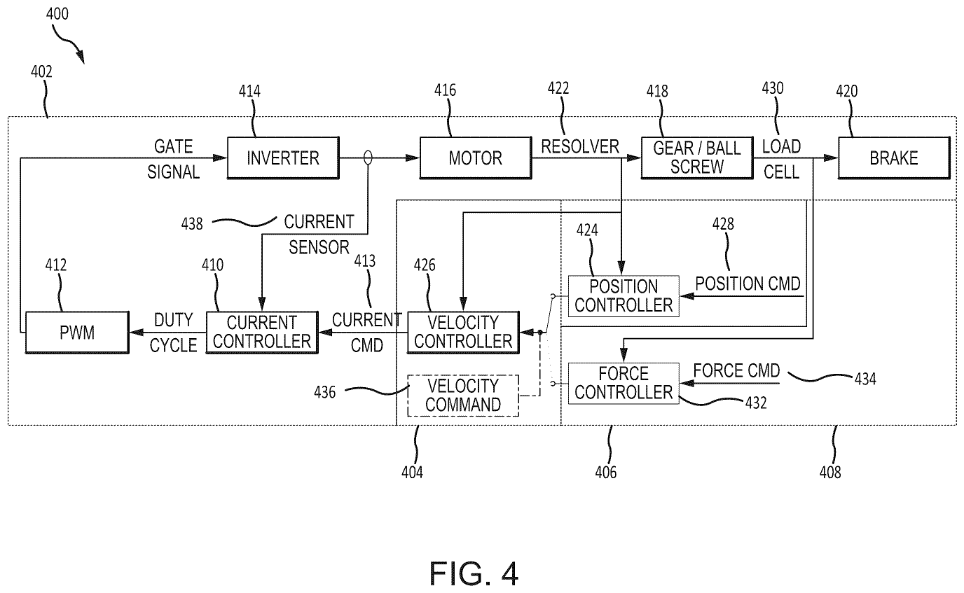

Referring to FIG. 4, in accordance with various embodiments, an Electric Brake Actuator Controller (EBAC) is illustrated. In various embodiments, the EBAC system 400 includes a series of cascaded control loops with the innermost loop being an electric current control loop 402, followed by a velocity control loop 404, and the outer-most loops being a position control loop 406 and a force control loop 408. In various embodiments, the electric current control loop 402 includes an electric current controller 410 configured to provide an electric current at a specified duty cycle to a pulse width modulator 412, based on an electric current command 413 from a velocity controller, which is described hereafter. In various embodiments, the pulse width modulator 412 provides a gate signal to an inverter 414, which causes the inverter 414 to output the commanded electric current to a motor 416. In various embodiments, response to receiving the commanded electric current, the motor 416 is configured to rotate which cases the gear/ball screw 418 to rotate and thereby apply a force to the pressure plate of the brake 420 as described above in FIG. 2.

In various embodiments, responsive to the motor 416 rotating, a resolver 422, which may be within or coupled to the motor 416, is configured to provide a position indication to position controller 424 in the position control loop 406 as well as to the velocity controller 426 in the velocity control loop 404. In various embodiments, the position controller 424 is configured to provide a corrective position command to the velocity controller 426 based on a received position command 428 from the BCU and the position indication from the resolver 422.

In various embodiment, responsive to the gear/ball screw 418 rotating and applying a pressure to the pressure plate of the brake 420, a load cell 430 is configured to provide a force indication to force controller 432 in the force control loop 408. In various embodiments, the force controller 432 is configured to provide a corrective force command to the velocity controller 426 based on a received force command 434 from the BCU and the force indication from the load cell 430.

In various embodiments, the velocity controller 426 is configured to receive a velocity command 436 from the BCU and issues a new electric current command 413 to the electric current controller 410 utilizing either the corrective position command from the position controller 424, the corrective force command from the force controller 432, or neither of the corrective position command or the corrective force command. In various embodiments, the electric current controller 410 is configured to provide a corrective electric current at a specified duty cycle to a pulse width modulator 412, based on the new electric current command 413 from a velocity controller 426 and an electric current detected by an electric current sensor 438, which is configured to detect the electric current output by the inverter 414.

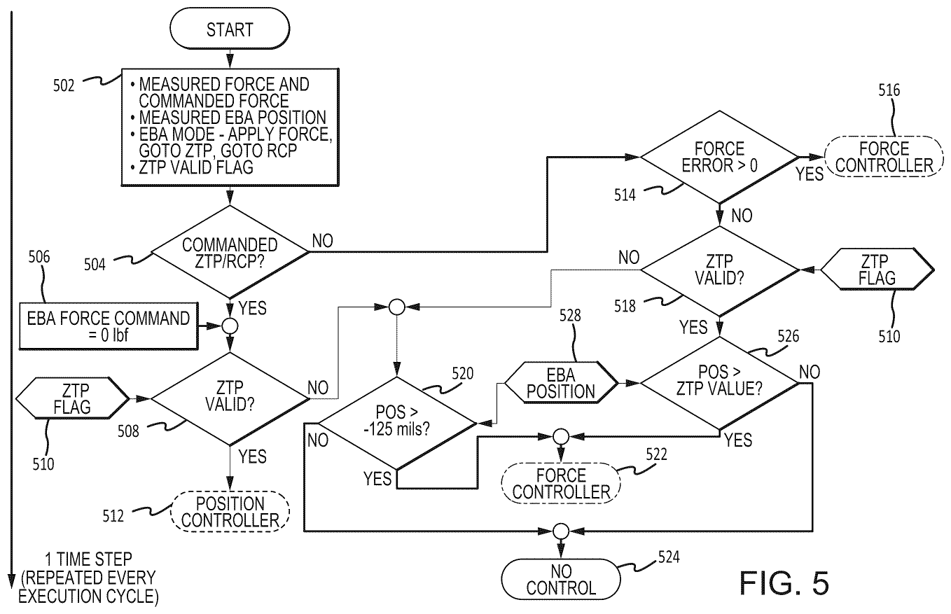

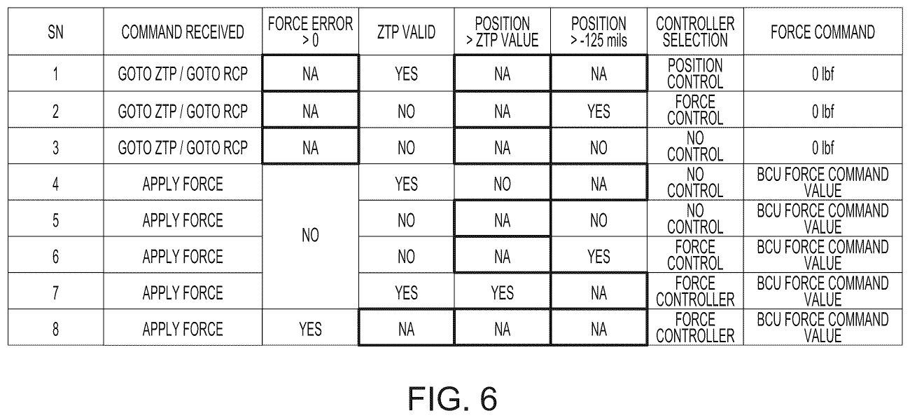

Referring now to FIGS. 5 and 6, in accordance with various embodiments, which describe a flow chart and a table, respectively, of velocity command selection by a motor velocity control selection mechanism of a velocity controller within an Electric Brake Actuator Controller (EBAC) are illustrated. As the operation begins, in various embodiments, at block 502, the velocity control selection mechanism of the velocity controller, such as the velocity controller 426 of FIG. 4, identifies a measured force; a commanded force from the BCU; a measured EBA position; a current EBA mode, such as apply force, go to zero torque point (ZTP), or running clearance point (RCP); a ZTP flag, i.e., a ZTP has been established.

In various embodiments, at block 504, the velocity control selection mechanism determines whether the command from the BCU is to either go to ZTP or go to RCP. In various embodiments, if at block 504, the command is to go to ZTP or go to RCP, the EBA force command 506 will be zero (0) and, at block 508, the velocity control selection mechanism determines whether the ZTP is valid as per the ZTP flag 510. In various embodiments, if at block 508, the velocity control selection mechanism determines that the ZTP is valid, then the velocity control selection mechanism selects, at block 512, the position controller, such as position controller 424 of FIG. 4, and utilizes the corrective position command from the position controller to provide new electric current command to the electric current controller, as described in FIG. 4, and aligns with line 1 of the table shown in FIG. 6.

In various embodiments, at block 504, if the velocity control selection mechanism determines that the command from the BCU is not to either go to ZTP or go to RCP, then, at block 514, the velocity control selection mechanism determines whether the force error is greater than zero (0), i.e., where the force error is determined by comparing a commanded force to a current measured force. In various embodiments, if at block 514, the velocity control selection mechanism determines the force error is greater than zero (0), then the velocity control selection mechanism selects, at block 516, the force controller, such as force controller 432 of FIG. 4, and utilizes the corrective force command from the force controller to provide new electric current command to the electric current controller, as described in FIG. 4, and aligns with line 8 of the table shown in FIG. 6.

In various embodiments, if at block 514, the velocity control selection mechanism determines the force error is equal to or less than zero (0), then, at block 518, the velocity control selection mechanism determines whether the ZTP is valid as per the ZTP flag 510. In various embodiments, if at block 508, the velocity control selection mechanism determines that the ZTP is invalid, then, at block 520, the velocity control selection mechanism determines whether the position indication is greater than −125 mils (−125 thousandths of an inch). In various embodiments, if at block 520 the position is greater than −125 mils, then the velocity control selection mechanism selects, at block 522, the force controller, such as force controller 432 of FIG. 4, and utilizes the corrective force command from the force controller to provide new electric current command to the electric current controller, as described in FIG. 4, and aligns with line 2 of the table shown in FIG. 6. In various embodiments, if at block 520 the position is equal to or less than-125 mils, then the velocity control selection mechanism selects, at block 524, no controller input, and utilizes the commanded force from the BCU, which aligns with line 3 of the table shown in FIG. 6.

In various embodiments, if at block 518, the velocity control selection mechanism determines that the ZTP is invalid, then, at block 520, the velocity control selection mechanism determines whether the position indication is greater than −125 mils. In various embodiments, if at block 520 the position is greater than −125 mils, then the velocity control selection mechanism selects, at block 522, the force controller, such as force controller 432 of FIG. 4, and utilizes the corrective force command from the force controller to provide new electric current command to the electric current controller, as described in FIG. 4, and aligns with line 6 of the table shown in FIG. 6. In various embodiments, if at block 520 the position is equal to or less than −125 mils, then the velocity control selection mechanism selects, at block 524, no controller input, and utilizes the commanded force from the BCU, which aligns with line 5 of the table shown in FIG. 6.

In various embodiments, if at block 518, the velocity control selection mechanism determines that the ZTP is valid, then, at block 526, the velocity control selection mechanism determines whether the EBA position 528 indication is greater than the ZTP value. In various embodiments, if at block 526, the EBA position 528 is equal to or less than the position indication, then the velocity control selection mechanism selects, at block 524, no controller input, and utilizes the commanded force from the BCU, which aligns with line 4 of the table shown in FIG. 6. In various embodiments, if at block 526, the EBA position 528 is greater than the position indication, then the velocity control selection mechanism selects, at block 522, the force controller, such as force controller 432 of FIG. 4, and utilizes the corrective force command from the force controller to provide new electric current command to the electric current controller, as described in FIG. 4, and aligns with line 7 of the table shown in FIG. 6.

Accordingly, the illustrative embodiments present an innovative method to select the velocity command from the force or position controller or disable the controllers based on different scenario to mitigate potential issue arising from invalid ZTP or load cell bias. The illustrative embodiments simplify the controller selection algorithm from the existing aircraft control selection algorithms by getting rid of the mix mode control, complex state machine implementation, and tunable parameters such as force thresholds and estimated brake force constant to estimate EBA position from the force command. The illustrative embodiments makes the algorithm more robust, simplifies the software implementation, and reduces the validation and verification efforts.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An electromechanical brake (E-brake) system, comprising:
a brake control unit;
an electromechanical brake actuator controller coupled to the brake control unit; and
at least one brake coupled to the electromechanical brake actuator controller, wherein the electromechanical brake actuator controller comprises:
a velocity controller, wherein the velocity controller is configured to command a braking force via an electromechanical brake actuator to the at least one brake based upon whether a command to go to at least one of zero torque point (ZTP) or running clearance point (RCP) has been received and at least one of a force error, a ZTP flag, and a measured electric brake actuator position.

2. The E-brake system of claim 1, wherein the electromechanical brake actuator controller further comprises:
a position controller, wherein the position controller is configured to provide a corrective position command to the velocity controller based on a received position command from the brake control unit and a position indication of the at least one brake and wherein the velocity controller is configured to command the braking force to the at least one brake via the electromechanical brake actuator utilizing a velocity command from the brake control unit and the corrective position command responsive to receiving the command to go to the at least one of zero torque point (ZTP) or running clearance point (RCP) and responsive to the ZTP flag being valid.

3. The E-brake system of claim 2, wherein the position indication is received from a resolver associated with the electromechanical brake actuator of the at least one brake.

4. The E-brake system of claim 2, wherein the electromechanical brake actuator controller further comprises:
a force controller, wherein the force controller is configured to provide a corrective force command to the velocity controller based on a received force command from the brake control unit and a force indication associated with the electromechanical brake actuator of the at least one brake and wherein, responsive to receiving the command to go to the at least one of zero torque point (ZTP) or running clearance point (RCP) and responsive to the ZTP flag being in valid, the velocity controller is configured to command the braking force to the at least one brake via the electromechanical brake actuator utilizing the velocity command from the brake control unit and the corrective force command responsive to determining that the position indication is greater than −125 mils.

5. The E-brake system of claim 2, wherein, responsive to receiving the command to go to the at least one of zero torque point (ZTP) or running clearance point (RCP), responsive to the ZTP flag being in valid, and responsive to determining that the position indication is at or less than the −125 mils, the velocity controller is configured to command the braking force to the at least one brake via the electromechanical brake actuator utilizing only the velocity command from the brake control unit.

6. The E-brake system of claim 1, wherein the electromechanical brake actuator controller further comprises:
a force controller, wherein the force controller is configured to provide a corrective force command to the velocity controller based on a received force command from the brake control unit and a force indication associated with the electromechanical brake actuator of the at least one brake and wherein the velocity controller is configured to command the braking force to the at least one brake via the electromechanical brake actuator utilizing a velocity command from the brake control unit and the corrective force command responsive to failing to receive the command to go to the at least one of zero torque point (ZTP) or running clearance point (RCP) and responsive to the force error being greater than zero (0), wherein the force error is determined by comparing a commanded force to a current measured force.

7. The E-brake system of claim 6, wherein the force indication is received from a load cell associated with the electromechanical brake actuator of the at least one brake.

8. The E-brake system of claim 6, wherein, responsive to the force error being equal to or less than zero (0) and responsive to the ZTP flag being in valid, the velocity controller is configured to command the braking force to the at least one brake via the electromechanical brake actuator utilizing the velocity command from the brake control unit and the corrective force command responsive to determining that a position indication of the at least one brake is greater than −125 mils.

9. The E-brake system of claim 6, wherein, responsive to the force error being equal to or less than zero (0), responsive to the ZTP flag being in valid, and responsive to determining that a position indication of the at least one brake is at or less than the −125 mils, the velocity controller is configured to command the braking force to the at least one brake via the electromechanical brake actuator utilizing only the velocity command from the brake control unit.

10. The E-brake system of claim 6, wherein, responsive to the force error being equal to or less than zero (0) and responsive to the ZTP flag being in valid, the velocity controller is configured to command the braking force to the at least one brake via the electromechanical brake actuator utilizing the velocity command from the brake control unit and the corrective force command responsive to determining an EBA position indication is equal to or less than a ZTP value.

11. The E-brake system of claim 6, wherein, responsive to the force error being equal to or less than zero (0), responsive to the ZTP flag being in valid, and responsive to determining an EBA position indication is greater than a ZTP value, the velocity controller is configured to command the braking force to the at least one brake via the electromechanical brake actuator utilizing only the velocity command from the brake control unit.

12. A method for controlling a force applied to at least one brake of an electromechanical brake (E-brake) system, the method comprising:
commanding, by a velocity controller, a braking force via an electromechanical brake actuator to the at least one brake based upon whether a command to go to at least one of zero torque point (ZTP) or running clearance point (RCP) has been received and at least one of force error, a ZTP flag, and a measured electric brake actuator position.

13. The method of claim 12, further comprising:
commanding, by the velocity controller, the braking force to the at least one brake via the electromechanical brake actuator utilizing a velocity command from a brake control unit and a corrective position command from a position controller, responsive to receiving a command to go to the at least one of zero torque point (ZTP) or running clearance point (RCP) and responsive to the ZTP flag being valid.

14. The method of claim 13, further comprising:
responsive to receiving the command to go to the at least one of zero torque point (ZTP) or running clearance point (RCP) and responsive to the ZTP flag being in valid, commanding, by the velocity controller, the braking force to the at least one brake via the electromechanical brake actuator utilizing the velocity command from the brake control unit and a corrective force command from a force controller responsive to determining that a position indication is greater than −125 mils.

15. The method of claim 13, further comprising:
responsive to receiving the command to go to the at least one of zero torque point (ZTP) or running clearance point (RCP), responsive to the ZTP flag being in valid, and responsive to determining that a position indication is at or less than the −125 mils, commanding, by the velocity controller, the braking force to the at least one brake via the electromechanical brake actuator utilizing only the velocity command from the brake control unit.

16. The method of claim 12, further comprising:
commanding, by the velocity controller, the braking force to the at least one brake via the electromechanical brake actuator utilizing a velocity command from a brake control unit and a corrective force command from a force controller, responsive to failing to receive the command to go to the at least one of zero torque point (ZTP) or running clearance point (RCP) and responsive to a force error being greater than zero (0), wherein the force error is determined by comparing a commanded force to a current measured force.

17. The method of claim 16, wherein, responsive to the force error being equal to or less than zero (0) and responsive to the ZTP flag being in valid, commanding, by the velocity controller, the braking force to the at least one brake via the electromechanical brake actuator utilizing the velocity command from the brake control unit and the corrective force command responsive to determining that a position indication of the at least one brake is greater than −125 mils.

18. The method of claim 16, wherein, responsive to the force error being equal to or less than zero (0), responsive to the ZTP flag being in valid, and responsive to determining that a position indication of the at least one brake is at or less than the −125 mils, commanding, by the velocity controller, the braking force to the at least one brake via the electromechanical brake actuator utilizing only the velocity command from the brake control unit.

19. The method of claim 16, wherein, responsive to the force error being equal to or less than zero (0) and responsive to the ZTP flag being in valid, commanding, by the velocity controller, the braking force to the at least one brake via the electromechanical brake actuator utilizing the velocity command from the brake control unit and the corrective force command responsive to determining an EBA position indication is equal to or less than a ZTP value.

20. The method of claim 16, wherein, responsive to the force error being equal to or less than zero (0), responsive to the ZTP flag being in valid, and responsive to determining an EBA position indication is greater than a ZTP value, commanding, by the velocity controller, the braking force to the at least one brake via the electromechanical brake actuator utilizing only the velocity command from the brake control unit.
